(19) United States
(12) Patent Application Publication
(10) Pub. No.: US 2003/0046441 A1
(43) Pub. Date: Mar. 6, 2003

(54) Teamware repository of teamware workspaces

(76) Inventors: Sadhana S. Rau, Palo Alto, CA (US); Anatoli Fomenko, San Jose, CA (US); Mark W. Dey, Oakland, CA (US); Nikolay Molchanov, Fremont, CA (US); Anatoly Zvezdin, Novosibirsk (RU)

Correspondence Address: ROSENTHAL & OSHA L.L.P., 1221 MCKINNEY AVENUE, SUITE 2800, HOUSTON, TX, 77010, US

(21) Appl. No.: 09/900,763

(22) Filed: Jul. 5, 2001

(51) Int. Cl. G06F 9/44

(52) U.S. Cl. 709/315; 709/203

(57) ABSTRACT

A mechanism for controlling access to workspaces includes a repository for storing the workspaces, an interface having a set of methods that can be invoked to access the repository, and a server having at least one server object which implements the interface.

### CROSS-REFERENCE TO RELATED APPLICATIONS

U.S. patent application Ser. No. ______, entitled “Teamware Server Working Over HTTP/HTTPS Connections,” filed contemporaneously herewith, contains subject matter related to the disclosure herein.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyright rights whatsoever.

### BACKGROUND OF THE INVENTION

1. Field of the Invention

The invention relates generally to “teamware,” a category of software that enables a team of people, especially people distributed over multiple locations, to collaborate on projects. More specifically, the invention relates to methods and systems for managing teamware workspaces.

2. Background Art

One of the major challenges in developing large-scale (multi-platform) software is coordinating the activities of a team of people, i.e., developers, testers, technical writers, and managers. To improve productivity, time-to-market, and quality of the software, the various phases of the development life cycle typically evolve concurrently, i.e., in parallel. Concurrent software development requires that the developers have access to common software base for the purpose of developing and building the software. The main challenge with this type of development process is how to control access to the software base and track the changes made to the software base so that the integrity of the software base is maintained. It should be noted that at any point in time, various configurations of the software base might exist because the various phases of the development cycle are evolving concurrently.

Most development teams use a Software Configuration Management (SCM) system to manage the software base. SCM systems, such as Concurrent Versions System (CVS), track the changes made to the files under their control and facilitate merging of code. Sophisticated SCM systems, such as Rational® ClearCase® from Rational Software Corporation and Forte™ TeamWare from Sun Microsystems, Inc., provide other capabilities such as software building and process management (e.g., what changes can be made to the software base and who can make the changes).

SCM systems, such as Forte TeamWare, allow creation of one or more isolated workspaces. The term “workspace” refers to a directory, its subdirectories, and the files contained in those directories. Typically, the files are maintained under a version control system, such as Source Code Control System (SCCS) or Revision Control System (RCS). To use Forte™ TeamWare for software management, the developers initially place their project directories and files (if available) in one high-level directory. Forte™ TeamWare then transforms the high-level directory into a top-level (or parent) workspace. If project directories and files are not available, an empty parent workspace is created. After creating the parent workspace, the developers create their own child workspaces with copies of the parent workspace files. The developers can then modify individual versions of the same file in their child workspaces without interfering with the work of other developers. After the files are modified in the child workspaces, they are merged and copied to the parent workspace. Merging of files generally involves resolving conflicts between individual versions of the same file.

Transactions between a child workspace and a parent workspace generally revolve around three relationships: copy files from the parent workspace to the child workspace, modify files in the child workspace, and copy files from the child workspace to the parent workspace. Forte™ TeamWare (version 6.0) as currently implemented exposes the workspace structure and its metadata structure to the end user, and there is no centralized control over the workspaces. This leaves the workspaces vulnerable to unauthorized and haphazard access and manipulation. In addition, it is hard to account for and trace all actions performed on the workspaces. Further, because the workspace structure and metadata structure are published (at the file system level), it is hard to change the format of the workspace to take advantage of more sophisticated structures and concepts. It is hard because third party vendors and application programmers rely on that public information to develop and maintain their own applications.

Therefore, a system for managing workspaces that provides centralized control over how the workspaces are accessed and allows the workspace structure to evolve independently is desired.

### SUMMARY OF THE INVENTION

In one aspect, the invention relates to a mechanism for controlling access to workspaces which comprises a repository for storing the workspaces, an interface having a set of methods that can be invoked to access the repository, and a server having at least one server object which implements the interface.

In another aspect, the invention relates to a system for accessing workspaces which comprises a repository for storing the workspaces, an interface having a set of methods that can be invoked to access the repository, a server having at least one server object which implements the interface, and at least one servlet which parses requests sent to the server and delegates processing of the request to the server object.

In another aspect, the invention relates to a system for remotely accessing workspaces in a network which comprises a repository for storing the workspaces, an interface having a set of methods that can be invoked to access the repository, a server having at least one server object which implements the interface, and a proxy object that can be called to forward a request for a method of the server object to the server.

In another aspect, the invention relates to a system for remotely accessing workspaces in a network which comprises a repository for storing the workspaces, an interface having a set of methods that can be invoked to access the repository, a server having at least one server object which implements the interface, a proxy object that can be called to forward a request for a method of the server object to the server, and a client that calls a method of the proxy object.

In another aspect, the invention relates to a system for remotely accessing workspaces in a client-server network which comprises a repository for storing the workspaces, an interface having a set of methods that can be invoked to access the repository, a server having at least one server object which implements the interface, a proxy object that can be called to forward a request for a method of the server object to the server, and a servlet which parses the request and delegates processing of the request to the server object.

In another aspect, the invention relates to a method for executing transactions in a network having a client-side and a server-side which comprises calling a method of a client-side proxy object that implements an interface having a set of methods that can be invoked to access a repository of workspaces and transmitting the method call to a server-side object which processes the method call and returns the result to the client-side proxy object.

In another aspect, the invention relates to a system for remotely accessing workspaces in a network which comprises a repository for storing the workspaces, an interface having a set of methods that can be invoked to access the repository, a server having at least one server object which implements the interface, and a mechanism for remotely invoking a method of the server object.

In another aspect, the invention relates to a system for remotely accessing workspaces in a network which comprises a repository for storing the workspaces, an interface having a set of methods that can be invoked to access the repository, a first server that provides management functions for the repository, and a second server having at least one server object that implements the interface and that interacts with the first server to access the repository.

Other features and advantages of the invention will be apparent from the following description and the appended claims.

### BRIEF DESCRIPTION OF THE DRAWINGS

FIG. 1 shows a block diagram of a teamware system that allows controlled access to workspaces in accordance with one embodiment of the invention.

FIG. 2 shows a block diagram of an alternate embodiment of the teamware system shown in FIG. 1.

FIG. 3 shows the teamware system of FIG. 1 at runtime.

FIG. 4 shows the teamware server of FIGS. 1-3 deployed as part of a web application.

FIG. 5 shows how a client object remotely invokes a method of a server object to access a repository.

### DETAILED DESCRIPTION

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

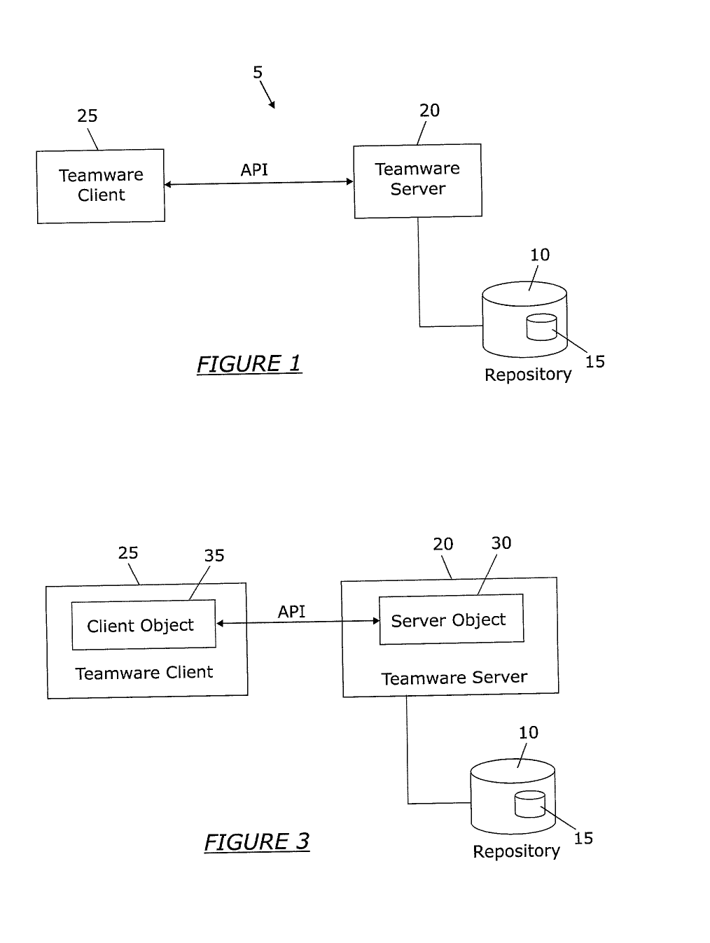

Referring now to the accompanying drawings, FIG. 1 shows a block diagram of a teamware system 5 that allows controlled access to workspaces in accordance with one embodiment of the invention. The teamware system 5 includes one or more repositories 10 (only one is shown). The term “repository” refers to an entity, e.g., a file system, where master copies of workspaces, or links to master copies of workspaces, are stored.

The term “workspace” refers to a directory, its subdirectories, and the files contained in those directories. A workspace inside the repository 10 is referred to as a “repository workspace.” At any given time, the repository 10 can contain zero, one, or more repository workspaces. For illustration purposes, the repository 10 is shown as containing one repository workspace 15. The workspace files are typically stored under a version control system, such as SCCS or RCS, so that changes made to the workspace files can be tracked.

The teamware system 5 further includes a teamware server 20 that manages and provides access to the repository 10 and its contents, e.g., repository workspace 15. A teamware client 25 sends messages to the teamware server 20 to access the repository 10 and its contents. As an example, the teamware client 25 may request for files in a specific repository workspace. If the request is successfully processed, the teamware server 20 returns the requested files to the teamware client 25. In order for the teamware client 25 to talk to the teamware server 20, a contract must exist between the teamware client 25 and the repository server 20. This contract is called an application programmer interface (API). The API specifies interface classes and their methods, along with their input, output, and return data structures. As long as the API remains the same, the implementations of the teamware client 25 and teamware server 20 can evolve independently. What this means is that the teamware server 20 can be modified to accommodate changes in the internal structure of the repository 10 and its contents without requiring modifications to be made to the teamware client 25.

In order to better understand the invention, it is useful to consider some examples of interfaces classes and methods that may be included in the interface classes. However, it should be clear that the following examples of interface classes are presented for illustration purposes and should not be construed as limiting the invention in any way. In particular, those skilled in the art will appreciate that the interface classes and methods specified by the API would depend on the functionality desired from the teamware server 20 with respect to management of and access to repositories (e.g., the repository 10) and their contents (e.g., repository workspace 15).

### EXAMPLE 1

As an example, one interface class that the API may include is called TwRepository interface class. As the name suggests, the TwRepository interface class includes methods for interacting with a teamware repository, such as repository 10. Table 1 below shows an example of the TwRepository interface class in Java™ notation. It should be noted that the interface definition shown in Table 1 is presented for illustration purposes and is not intended to limit the scope of the invention as otherwise described herein.

TABLE 1
Interface Definition for TwRepository Interface
<<interface>>
TwRepository

© 2001 Sun Microsystems, Inc.
/* Tells compiler that class belongs to this package */
package com.sun.teamware.rt;
/* Imports supporting class */
import java.util.List;
/* Provides API for the teamware repository */
public interface TwRepository {

/* Returns the versions of API supported by the repository. Throws
exception if the request was not successful.*/
public List getSupportedVersions() throws TwServerException;
/* Creates a workspace instance for the requested workspace in the
repository and returns a repository workspace object for specified
workspace name. Throws exception if the request was not
successful.*/
public TwRepositoryWorkspace getTwRepositoryWorkspace(String
workspacename) throws TwServerException;
/* Returns a list of repository workspaces accessible to the user.
Throws exception if the request was not successful.*/
public List listWorkspaces() throws TwServerException;
/* Creates a repository workspace by specified name. Throws
exception if the request was not successful.*/
public void createWorkspace(String workspacename) throws
TwServerException;
/* Deletes a repository workspace by specified name. Throws
exception if the request was not successful.*/
public void deleteWorkspace(String workspacename) throws
TwServerException;
/* Renames a repository workspace by specified new name. Throws
exception if the request was not successful.*/
public void rename renameWorkspace(String oldWorkspacename,
String newWorkspacename) throws TwServerException;
/* Locks the repository. Throws exception if the request was not
successful.*/
public void lock() throws TwServerException;
/* Unlocks the repository. Throws exception if the request was not
successful.*/
public void unlock() throws TwServerException;

}

### EXAMPLE 2

As an example, another interface class that the API may include is called TwRepositoryWorkspace interface class. The TwRepositoryWorkspace interface class includes methods for interacting with a repository workspace, such as repository workspace 15. Table 2 below shows an example of the TwRepository interface class in Java™ notation. In the interface definition shown in Table 2, TwRepository interface extends TwWorkspace interface. The TwWorkspace interface class includes methods for performing various general operations on a workspace, such as checking if a workspace is equal to a given object, checking whether a given workspace physically exists, checking whether a user has access for a specified operation, adding children to a workspace, removing children from a workspace, getting the children of a workspace, getting the parent of a workspace, and so forth. Again, it should be noted that the interface definition shown in Table 2 is presented for illustration purposes and is not intended to limit the scope of the invention as otherwise described herein.

TABLE 2
Interface Definition for TwRepositoryWorkspace Interface
<<interface>>
TwRepositoryWorkspace

© 2001 Sun Microsystems, Inc.
/* Tells compiler that class belongs to this package */
package com.sun.teamware.rt;
/* Imports supporting classes */
import java.io.File;
import java.io.InputStream;
import com.sun.teamware.TwWorkspace;
/* Provides API for the repository workspace */
public interface TwRepositoryWorkspace extends TwWorkspace {

/* Creates an empty cache for a given workspace connection. Throws
exception if the request was not successful.*/
public void createCache() throws TwServerException;
/* Deletes the cache for a given workspace connection. Throws
exception if the request was not successful.*/
public void deleteCache() throws TwServerException;
/* Returns the file specified by relativeFilename from the cache
workspace as a stream. Throws exception if the request was not
successful. */
public InputStream getCacheFile(String relativeFilename) throws
TwServerException;
/*Saves an input stream to a file specified by relativeFilename into
the workspace cache on the server. Throws exception if the request
was not successful.*/
public void putCacheFIle(InputStream istream, String
relativeFilename) throws TwServerException;
/* Returns the transaction object that can be used to update the
workspace from its cache. Throws exception if the request was not
successful.*/
public TwTransaction
getPutbackFromCacheTransaction(TwTransactionOptions
transactionOptions) throws TwServerException;
/* Requests the server to keep the connection to the server alive.
Throws exception if the request was not successful.*/
public void keepAlive() throws TwServerException;

}

### EXAMPLE 3

As an example, another interface class that the API may include is called TwTransaction interface class. The TwTransaction interface class includes methods related to conducting transactions with the repository.

TABLE 3
Interface Definition for TwTransaction Interface
<<interface>>
TwTransaction

© 2001 Sun Microsystems, Inc.
/* Tells compiler that class belongs to this package */
package com.sun.teamware.rt;
/* Imports supporting class */
import java.util.List;
public interface TwTransaction {

/* Returns transaction output object. Throws exception if request was
not successful.*/
public TwTransactionOutput getOutput() throws TwException;
/* Returns status of transaction. Throws exception if request was not
successful.*/
public int getStatus() throws TwException;
/* Returns list of initialization parameters for transaction. Throws
exception if the request was not successful.*/
public List init() throws TwException;
/* Starts transaction. Throws exception if the request was not
successful.*/
public start() throws TwException;
/* Stops transaction. Throws exception if the request was not
successful.*/
public void stop() throws TwException;

}

### EXAMPLE 4

As an example, another interface class that the API may include is called TwServer interface class. The TwServer interface class includes methods for accessing the teamware server. Table 4 below shows an example of the TwServer interface class in Java™ notation. Again, it should be noted that the interface definition shown in Table 4 is presented for illustration purposes and is not intended to limit the scope of the invention as otherwise described herein.

TABLE 4
Interface Definition for TwServer Interface
<<interface>>
TwServer

© 2001 Sun Microsystems, Inc.
/* Tells compiler that class belongs to this package */
package com.sun.teamware.rt;
/* Imports supporting classes */
import java.io;
import java.net.URL;
import java.net.URLConnection;
import java net.HttpURLConnection;
import java.net.MalformedURLException;
import java.util.List;
import java.util.Properties;
/* Provides API for accessing repositories using server configuration */
public interface TwServer {

/* Allows user to log into the repository with specified username and
password and returns repository object. Throws exception if the user
was not successfully logged in.*/
public TwRepository logintoRepository(String username, String
password, String repositoryname) throws TwServerException;
/* Allows the user to log out from the server. Cleans up the teamware
TwServer connection and related context. Throws exception if the
user was not successfully logged out.
public void logoutofRepository(TwRepository twRepository) throws
TwServerException;
/* Returns the versions of API supported by the repository server.
Throws exception if the request was not successful.*/
public List getSupportedVersions() throws TwException;
/* Sets a property for the teamware server with the specified value.
Throws exception if the request was not successful.*/
public void setServerProperty(String property, String value) throws
TwServerException;
/* Sends specific requests to the server to execute on the server.
Throws TwServerException if the request was not successful.*/
public void sendServerRequest(String operation, Properties
parameters) throws TwServerException;

}

### EXAMPLE 5

As an example, another interface class that the API may include is called TwAdminServer interface class. The TwAdminServer interface class includes administration-related methods. For example, the AdminServer interface class may include the methods shown in Table 5 below.

TABLE 5
Interface Definition for TwAdminServer Interface
<<interface>>
TwAdminServer

© 2001 Sun Microsystems, Inc.
/* Tells compiler that class belongs to this package */
package com.sun.teamware.rt;
/* Imports supporting class */
import java.io;
import java.net.URL;
import java.net.URLConnection;
import java.net.HttpURLConnection;
import java.net.MalformedURLException;
import java.util.List;
import java.util.Properties;
/* Provides API to edit the server configuration */
public interface TwAdminServer {

/* Allows user to log into the server with specified username and
password. Throws exception if the user was not successfully logged
in.*/
public void login(String username, String password) throws
TwServerException;
/* Allows user to log out from the server. It cleans up the
TwAdminServer connection and related context. Throws exception
if the user was not successfully logged out.
public void logout() throws TwServerException;
/* Creates a repository by specified name. Throws exception if the
request was not successful.*/
public void createRepository(String repositoryname) throws
TwServerException;
/* Deletes a repository by specified repository name. Throws
exception if the request was not successful.*/
public void deleteRepository(String sid) throws TwServerException;
/* Renames a repository to a specified repository name. Throws
exception if the request was not successful.*/
public void renameRepository(String sid, String repositoryname)
throws TwServerException;
/* Registers the specified repository with the server. Throws
exception if the request was not successful.*/
public void registerRepository(String repositoryname) throws
TwServerException;
/* Un-registers the specified repository with the server. Throws
exception if the request was not successful.*/
public void unregisterRepository(String repositoryname) throws
TwServerException;
/* Returns the versions of API supported by the Tw repository server.
Throws exception if the request was not successful.*/
public List getSupportedVersions() throws TwServerException;
/* Returns list of repositories registered with the server. Throws
exception if the request was not successful.*/
public List listRepositories() throws TwServerException;
/* Sets a property for the server with the specified value. Throws
TwServerException if the request was not successful.*/
public void setServerProperty(String property, String value) throws
TwServerException;

}

As previously mentioned, the examples above are presented for illustration purposes and should not be construed as limiting the invention in any way. The main idea is that by providing a server-based API, all teamware clients, whether local or remote, will be guaranteed access to the repository and its contents in exactly the same way. Further, by providing the server-based API as the means for accessing the repository and its contents, it becomes unnecessary to publish the internal structure of the repository. This allows the internal structure of the repository, including the structure of the repository workspaces, to evolve independently. The internal implementation of the teamware server 20, which will not be published, can be modified as necessary to accommodate new repository structure. As long as the API remains the same, it will not be necessary to modify the teamware clients.

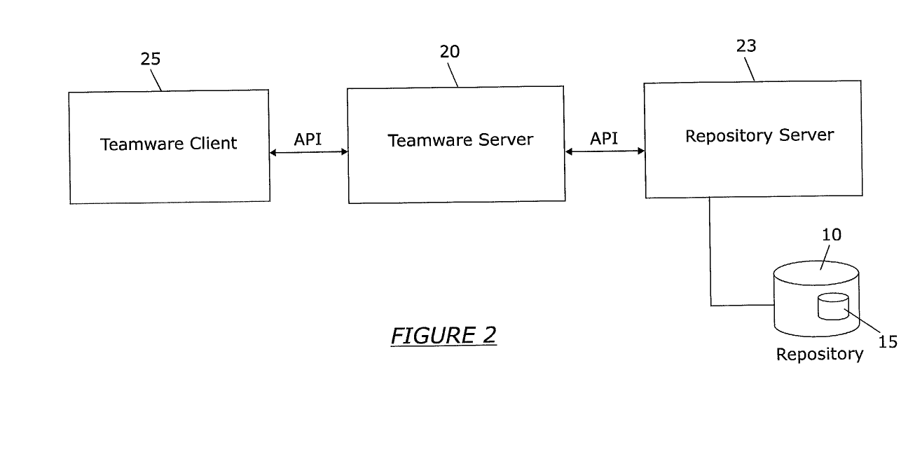

FIG. 2 shows a block diagram of an alternate embodiment of the teamware system 5. In this embodiment, the teamware system 5 includes a repository server 23 that performs repository management functions, including regulation of access to repositories, such as repository 10, and their contents. The teamware client 25 accesses the repository 10 and its contents, such as repository workspace 15, by sending messages to and receiving responses from the teamware server 20. The teamware server 20 in turn interacts with (connects to) the repository server 23 to access the repository 10 and repository workspace 15. As in the embodiment illustrated in FIG. 1, the teamware client 25 interacts with the teamware server 20 through the API. Scalability is one of the reasons for introducing the repository server 23. The teamware server 20 can handle teamware management functions and delegate repository management functions to the repository server 23. In this way, if the internal structure of the repository changes, only the implementation of the repository server 23 may need to be modified. As long as the API remains the same, the implementation of the teamware client 25 would also not have to be modified.

Returning to FIG. 1, the teamware client 25 and teamware server 20 may be software components written in Java or another object-oriented programming language. At runtime, as shown in FIG. 3, the teamware server 20 includes one or more server objects 30 (only one is shown) that implement the API. A client object 35 invokes a server method by sending a message to the server object 30. The server object 30 executes the corresponding operation and returns the result to the client object 35. The internal implementation of the server object 30 is not visible to the client object 35. Thus, the server methods that can be invoked by the client object 35 are the ones specified in the API. At runtime, the client object 35 and server object 30 belong to different address spaces in the same computer or may even reside on different computers connected by a network. Because of this, a client object 35 cannot directly create server objects. Instead, new server objects are created by other objects already in the teamware server 20, and the initial server object (or set of server objects) is created when the teamware server 20 starts up. For example, this initial server object may be an object factory/manager (or a set of object factories/managers) that can create other server objects.

When the teamware client 25 and teamware server 20 run in different virtual machines, the server object 30 is remote to the client object 35. If the virtual machines are located on the same computer or on separate computers connected via a network file sharing system, such as Network File System (NFS) or Server Message Block (SMB), a mechanism such as Remote Method Invocation (RMI) can be used to remotely invoke the methods of the server object 30. The RMI mechanism (not shown) includes a stub/skeleton layer, a remote reference layer, and a transport layer. On the client side, the stub/skeleton layer includes a stub that acts as a proxy for the remote (server) object 30. The stub has the same interface, or list of methods, as the remote object 30. When the client object 35 calls the stub method, the stub forwards the request via the remote reference layer and transport layer to the remote object 30. On the server side, the stub/skeleton layer includes a skeleton that invokes the method on the actual remote object 35 implementation. The transport layer is based on TCP/IP (“Transport Control Protocol/Internet Protocol”) connections between machines in the network.

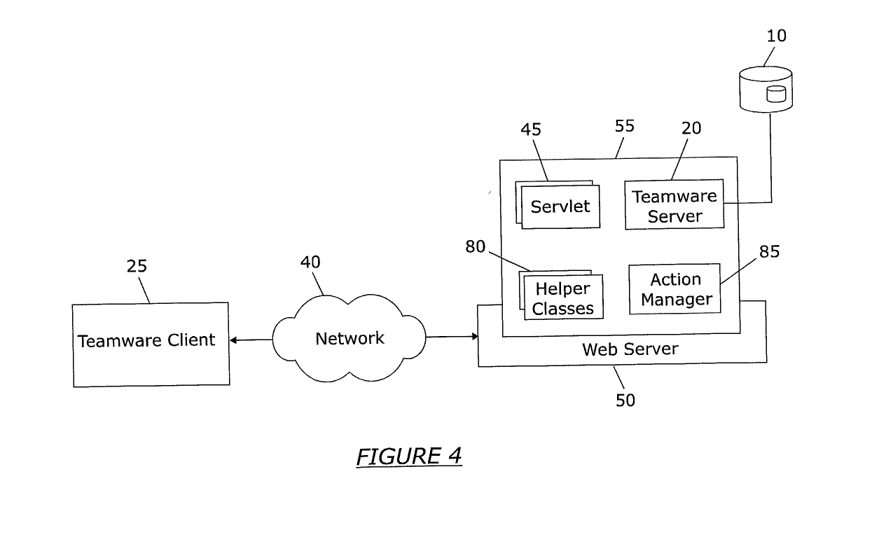

If the virtual machines are on separate computers that are not connected by a network file sharing system, another mechanism is needed to allow object-to-object communication between the virtual machines. This mechanism could be similar to the one described in U.S. patent application Ser. No. ______, entitled “Teamware Server Working Over HTTP/HTTPS Connections.” In accordance with this embodiment, as shown in FIG. 4, one or more servlets 45 serve as an interface between the teamware server 20 and the rest of the teamware system. Servlets are small platform-independent programs that extend the functionality of a server. Java™ 2 Platform, Enterprise Edition (J2EE™) includes JavaServlet™ API for developing servlets. In this embodiment, the teamware server 20 and servlets 45 are deployed on a web server 50 having built-in (in-process) or connector-based (out-of-process) web container 55. The web container 55 is a runtime which provides an implementation of the JavaServlet™ API. The web container 55 is responsible for initializing, invoking, and managing the lifecycle of the servlet. The servlets 45 parse requests from the teamware client 25 and delegate processing of the request to specific server objects in the teamware server 20.

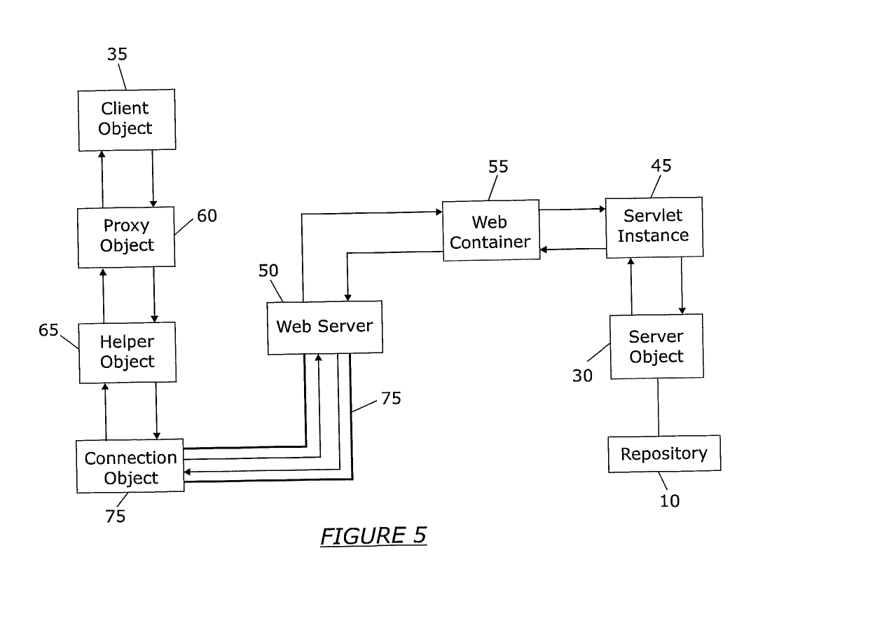

Typically, the teamware client 25 keeps the transaction logic and executes it locally. Certain commands (remote method calls) are passed to the teamware server 20 via the servlet (or servlets) 45 and executed at the teamware server 20. The result of the method call, such as the content of a file, an object, or an exception, is returned to the teamware client 25 via the servlet 45. Referring to FIG. 5, to invoke the method of the server (remote) object 30, the client object 35 makes a method call to a local proxy object 60 which has the same interface as the server object 30. When the client object 35 calls the proxy method, the proxy object 60 forwards the method call to a helper object 65. The helper object 65 analyzes the method call, marshals the parameters, and converts the method call to a HTTP request, including HTTP headers and object (if the parameters are objects) or input stream (if the parameter is an input stream). Marshaling is the process of converting data or object being transferred into a byte stream. Un-marshaling is the reverse of marshaling. The helper object 65 passes the HTTP request to a connection object 70, which sets up a connection 75 (over the network 40 in FIG. 4) with the web server 50 and sends the HTTP request to the web server 50 over the connection 75.

The connection 75 is based on HTTP or HTTPS protocol. HTTP (“Hypertext Transfer Protocol”) is an application-level protocol used in connecting servers and clients (browsers) on the World-Wide Web (WWW) or Internet. HTTP is based on a request-response paradigm and uses TCP (“Transmission Control Protocol”) connections to transfer data. HTTPS (“Hypertext Transfer Protocol Secure”) is a variant of HTTP that implements the SSL (“Secure Sockets Layer”) mechanism. SSL is a standard protocol developed by Netscape Communications Corporation for implementing cryptography and enabling secure transactions on the Web. SSL uses public key signatures and digital certificates to authenticate a server and client and provides an encrypted connection for the client and server to exchange messages securely. Any of these protocols can be used to transmit HTTP requests to the web server 50.

When the web server 50 receives the HTTP request, the web server 50 determines that the web container 55 should handle the HTTP request and passes the HTTP request to the web container 55. The web container 55 determines which of the servlets in the web application should generate the response. In a web application, an HTTP request can be mapped to a servlet. This mapping information is specified when the web application is deployed. The web application can use this mapping information to map the incoming request to a servlet. Alternatively, the HTTP request may include the URL of the servlet. The web container 55 creates or locates a servlet instance, indicated at 45, and delegates the request to the servlet. The web container 55 also creates response and request objects and passes the objects to the servlet as parameters.

Before handling a request, the servlet 45 typically performs authentication. The term “authentication” refers to the process by which one subject, which may be a user or a computing service, verifies the identity of another subject in a secure fashion. This process typically involves the subject demonstrating some form of evidence, such as a password or signed data using a private key, to prove its identity. Depending on the security parameters of a particular service, different kinds of proof may be required for authentication. If authentication completes successfully, the servlet 45 uses helper classes 80 to un-marshal the parameters included in the HTTP request before invoking a method on the server object 30. The servlet 45 then delegates processing of the method call to the server object 30. The server object 30 processes the method call and returns the results to the servlet 45. The return value or exception of the method call is marshaled by the helper classes 80 and included in a response object. The web container 55 passes the response to the web server 50, and the web server 50 sends the response to the teamware client 25 over the connection 75. At the client-side, the helper object 65 is used to un-marshal the response, and the result is returned to the calling object, i.e., client object 35.

The login/logout methods defined in the API (see, e.g., Table 5) allow users to authenticate themselves and create a session on the teamware server 20, which is identified by session_id. The session_id gets passed between the client object 35 and a server-side object, e.g., server object 30, during a given transaction. The client requests to the servlet 45 include the session_id. If the session_id is still valid, the user does not have to login for every task handled by the servlet 45. Logout is an explicit client request to end the current session. Other IDs, such as workspace_id and transaction_id, are also included in the HTTP request. Workspace_id identifies the server-side repository workspace object to be accessed, and transaction_id identifies the server-side transaction object being executed. At the teamware server 20, the IDs are stored in tables (session tables). The teamware server 20 includes a server class (85 in FIG. 4) called ActionManager, which manages the information stored in the session tables. ActionManager is instantiated during initialization of the servlet 45. The servlet 45 uses the ActionManager and the session information to determine which server-side object, e.g., server object 30, that will process the method call.

To protect the repository 10 from other users on the web server 50, the teamware server 20 may be deployed on the web server 50 by an administrator. For example, the installer could be “root.” Then all the installed files will be owned by root. When the process that represents the web server 50 is started by executing a file that is a setup user id file, the effective user id (which is used to check file permissions) of the process is set to the owner of the file executed, which in this case is root. This allows the web server 50 to have root permissions as far as managing files on the teamware server 20. When the administrator creates repositories on the teamware server 20, the administrator can set permissions so that only root can access the repositories. In this manner, the web server 50 can access the repositories, but not any random user on the web server 50. Thus, only root can delete or move the repositories. This scheme allows the web server 50 as a user other than root and yet has proper permissions to manage files on the teamware server 20.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A mechanism for controlling access to workspaces, comprising:
a repository for storing the workspaces;
an interface having a set of methods that can be invoked to access the repository; and
a server having at least one server object which implements the interface.

2. The mechanism of claim 1, wherein the workspaces comprise files stored under a version control abstraction.

3. The mechanism of claim 1, further comprising a servlet which parses requests sent to the server and delegates processing of the requests to the server object.

4. The mechanism of claim 1, wherein the server communicates using HTTP protocol.

5. The mechanism of claim 1, wherein the server communicates using HTTPS protocol.

6. A system for accessing workspaces, comprising:
a repository for storing the workspaces;
an interface having a set of methods that can be invoked to access the repository;
a server having at least one server object which implements the interface; and
at least one servlet which parses requests sent to the server and delegates processing of the request to the server object.

7. The system of claim 6, further comprising a container which provides runtime support for the servlet.

8. The system of claim 7, wherein the container is built into a web server.

9. The system of claim 7, wherein the container is connected to a web server.

10. A system for remotely accessing workspaces in a network, comprising:
a repository for storing the workspaces;
an interface having a set of methods that can be invoked to access the repository;
a server having at least one server object which implements the interface; and
a proxy object that can be called to forward a request for a method of the server object to the server.

11. The system of claim 10, wherein the proxy object implements the interface.

12. The system of claim 10, further comprising a servlet which receives the request and delegates processing of the request to the server object.

13. The system of claim 12, further comprising a container which provides runtime support for the servlet.

14. The system of claim 13, wherein the container is built into a web server.

15. The system of claim 13, wherein the container is connected to a web server.

16. The system of claim 12, wherein the request is forwarded to the server using HTTP protocol.

17. The system of claim 12, wherein the request is forwarded to the server using HTTPS protocol.

18. The system of claim 10, wherein the workspaces comprise files stored under a version control abstraction.

19. A system for remotely accessing workspaces in a network, comprising:
a repository for storing the workspaces;
an interface having a set of methods that can be invoked to access the repository;
a server having at least one server object which implements the interface;
a proxy object that can be called to forward a request for a method of the server object to the server; and
a client that calls a method of the proxy object.

20. The system of claim 19, wherein the proxy object implements the interface.

21. The system of claim 19, further comprising a servlet which receives the request and delegates processing of the request to the server object.

22. The system of claim 21, wherein the request is transmitted to the servlet over a HTTP connection.

23. The system of claim 21, wherein the request is transmitted to the servlet over a HTTPS connection.

24. The system of claim 19, wherein the workspaces comprise files stored under a version control abstraction.

25. A system for remotely accessing workspaces in a client-server network, comprising:
a repository for storing the workspaces;
an interface having a set of methods that can be invoked to access the repository;
a server having at least one server object which implements the interface;
a proxy object that can be called to forward a request for a method of the server object to the server; and
a servlet which parses the request and delegates processing of the request to the server object.

26. The system of claim 25, further comprising a container which provides runtime support for the servlet.

27. The system of claim 26, wherein the request is forwarded to the server using HTTP protocol.

28. The system of claim 26, wherein the request is forwarded to the server using HTTPS protocol.

29. The system of claim 25, wherein the proxy object implements the interface.

30. The system of claim 25, wherein the workspaces comprise files stored under a version control abstraction.

31. A method for executing transactions in a network having a client-side and a server-side, comprising:
calling a method of a client-side proxy object that implements an interface having a set of methods that can be invoked to access a repository of workspaces; and
transmitting the method call to a server-side object which processes the method call and returns the result to the client-side proxy object.

32. The method of claim 31, wherein transmitting the method call to the server-side object comprises translating the method call into a client request.

33. The method of claim 31, wherein transmitting the method call to the server-side object further includes transmitting the client request to a server.

34. The method of claim 33, wherein transmitting the client request to the server is based on HTTP protocol.

35. The method of claim 33, wherein transmitting the client request to the server is based on HTTPS protocol.

36. The method of claim 33, further comprising invoking a servlet to generate a response for the client request.

37. The method of claim 36, wherein the servlet delegates processing of the client request to the server-side object.

38. The method of claim 31, wherein a method of the client-side proxy object is called as a result of executing a command on the client-side.

39. A system for remotely accessing workspaces in a network, comprising:
a repository for storing the workspaces;
an interface having a set of methods that can be invoked to access the repository;
a server having at least one server object which implements the interface; and
a mechanism for remotely invoking a method of the server object.

40. The system of claim 39, wherein the mechanism comprises a stub which acts as a proxy for the server object and a skeleton that invokes the method on the server object.

41. A system for remotely accessing workspaces in a network, comprising:
a repository for storing the workspaces;
an interface having a set of methods that can be invoked to access the repository;
a first server that provides management functions for the repository; and
a second server having at least one server object that implements the interface and that interacts with the first server to access the repository.

42. The system of claim 41, further comprising a client that sends messages to and receives responses from the second server.

43. The system of claim 42, further comprising a mechanism for remotely invoking a method of the server object.

44. The system of claim 41, wherein the first server comprises at least one object which implements the interface.
